(19) United States
(12) Patent Application Publication
(10) Pub. No.: US 2007/0252878 A1
(43) Pub. Date: Nov. 1, 2007

(54) LIQUID DISCHARGE APPARATUS, INKJET PRINTER AND LIQUID DISCHARGING METHOD

(75) Inventors: Seiichi Yokoyama, Tomi-city (JP); Tomokazu Seki, Tomi-city (JP)

Correspondence Address: DITTHAVONG MORI & STEINER, P.C., 918 Prince St., Alexandria, VA, 22314, US

(73) Assignee: Mimaki Engineering Co., Ltd., Tomi-city (JP)

(21) Appl. No.: 11/733,550

(22) Filed: Apr. 10, 2007

(30) Foreign Application Priority Data
Apr. 28, 2006 (JP) 2006-124765

(51) Int. Cl. B41J 2/17

(52) U.S. Cl. 347/94

(57) ABSTRACT

A liquid discharge apparatus includes a pressure chamber which is connected to a nozzle via a nozzle passage and in which a liquid pressure is configured to be changed to discharge liquid from the nozzle. A liquid supply passage connects a liquid supply chamber and the pressure chamber. A fluid resistance providing mechanism is provided in at least one of the liquid supply passage and the nozzle passage. A first fluid resistance of the fluid resistance providing mechanism along a first flow direction from the liquid supply chamber toward the nozzle is smaller than a second fluid resistance of the fluid resistance providing mechanism along a second flow direction from the nozzle toward the liquid supply chamber.

### CROSS-REFERENCE TO RELATED APPLICATIONS

The present application claims priority under 35 U.S.C. §119 to Japanese Patent Application No. 2006-124765, filed Apr. 28, 2006, entitled “LIQUID DISCHARGE APPARATUS.” The contents of this application are incorporated herein by reference in their entirety.

### BACKGROUND OF THE INVENTION

1. Field of the Invention

The present invention relates to a liquid discharge apparatus, an inkjet printer and a liquid discharging method.

2. Discussion of the Background

FIG. 13 shows a typical inkjet apparatus to be used for printers. Referring to this figure, an inkjet apparatus includes a head body 200, a nozzle opening 201 from which liquid (liquid ink) is to be discharged, a pressure chamber 202, a liquid channel 203, a liquid supply chamber 204, a diaphragm 205 for covering an upper opening of the pressure chamber 202, and an actuator 206 such as a piezoelectric element for displacing the diaphragm 205 vertically. In addition, the nozzle opening 201, the pressure chamber 202, the liquid channel 203 and the liquid supply chamber 204 are all formed within the head body 200 by means of, for example, the photo-etching process. The liquid supply chamber 204 is supplied with liquid ink from a supply opening 204a. This liquid ink is then supplied to the pressure chamber 202 and the nozzle opening 201 through the liquid channel 203. Finally, the ink becomes full in all of them.

Now, an operation of a printer equipped with the above inkjet apparatus will be explained.

The actuator 206 is moved vertically, for example, by applying a predetermined voltage to the piezoelectric element. Due to this movement, the diaphragm 205 displaces vertically, and the liquid pressure in the pressure chamber 202 changes. When the diaphragm 205 is moved downward by the actuator 206, in other words, when the liquid pressure within the pressure chamber 202 increases, the liquid ink is discharged from the end opening 201a of the nozzle opening 201.

In addition, simultaneously with the discharge, the liquid is made to flow toward the liquid supply chamber 204. Note that this flow direction of the liquid is called “reverse direction”. In order to decrease this reverse current, the cross-section area of the liquid channel 203, which couples the pressure chamber 202 to the liquid supply chamber 204, is made small. In other words, the liquid channel 203 is made narrow. Consequently, the liquid channel 203 has a large fluid resistance in the reverse direction. In general, the fluid resistance of the liquid channel 203 is set to be the same as that of the nozzle opening 201. The quantity of the liquid discharged from the nozzle opening 201 is substantially the same as flowing into the liquid supply chamber 204 through the liquid channel 203.

On the other hand, when the diaphragm 205 is moved upward by the actuator 206, the volume of the liquid within the pressure chamber 202 increases, so that the liquid pressure is lowered. In this case, the liquid in the nozzle opening 201 is absorbed toward the pressure chamber 202. However, the liquid stays in the end opening 201a while forming a meniscus, due to its surface tension. Consequently, air is prevented from flowing into the pressure chamber 202. At the same time, the liquid in the liquid supply chamber 204 is absorbed toward the pressure chamber 202, and it then supplied to the pressure chamber 202 through the liquid channel 203. Note that this supply direction is called “forward direction”. The examples of such an inkjet apparatus are disclosed in Japanese Unexamined Patent Application Publications Nos. 2005-47165 and 2005-67047. The contents of these publications are incorporated by reference in their entirety.

### SUMMARY OF THE INVENTION

According to one aspect of the present invention, a liquid discharge apparatus includes a pressure chamber which is connected to a nozzle via a nozzle passage and in which a liquid pressure is configured to be changed to discharge liquid from the nozzle. A liquid supply passage connects a liquid supply chamber and the pressure chamber. A fluid resistance providing mechanism is provided in at least one of the liquid supply passage and the nozzle passage. A first fluid resistance of the fluid resistance providing mechanism along a first flow direction from the liquid supply chamber toward the nozzle is smaller than a second fluid resistance of the fluid resistance providing mechanism along a second flow direction from the nozzle toward the liquid supply chamber.

According to another aspect of the present invention, an inkjet printer includes a pressure chamber which is connected to a nozzle via a nozzle passage and in which an ink pressure is configured to be changed to discharge ink from the nozzle. An ink supply passage connects an ink supply chamber and the pressure chamber. A fluid resistance providing mechanism is provided in at least one of the ink supply passage and the nozzle passage. A first fluid resistance of the fluid resistance providing mechanism along a first flow direction from the ink supply chamber toward the nozzle is smaller than a second fluid resistance of the fluid resistance providing mechanism along a second flow direction from the nozzle toward the ink supply chamber.

According to further aspect of the present invention, a liquid discharging method includes providing a fluid resistance providing mechanism in at least one of a liquid supply passage and a nozzle passage. The liquid supply passage connects a liquid supply chamber and a pressure chamber. The nozzle passage connects the pressure chamber and a nozzle. A first fluid resistance of the fluid resistance providing mechanism along a first flow direction from the liquid supply chamber toward the nozzle is smaller than a second fluid resistance of the fluid resistance providing mechanism along a second flow direction from the nozzle toward the liquid supply chamber. A liquid pressure in the pressure chamber is changed to discharge liquid from the nozzle.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a vertical cross-section view depicting an inkjet apparatus including a liquid discharge device according to a first embodiment of the present invention;

FIG. 2 is a lateral cross-sectional view depicting the inkjet apparatus;

FIG. 3 is an enlarged lateral cross-sectional view depicting a liquid valve of the inkjet apparatus;

FIG. 4 is an enlarged lateral cross-section view depicting the operation of the liquid valve;

FIG. 5 is an enlarged lateral cross-sectional view depicting the operation of the liquid valve;

FIG. 6 is an enlarged vertical cross-sectional view depicting the operation of the inkjet apparatus;

FIG. 7 is an enlarged vertical cross-sectional view depicting the operation of the inkjet apparatus;

FIG. 8 is a lateral cross-sectional view depicting an inkjet apparatus according to a second embodiment of the present invention;

FIG. 9 is a lateral cross-sectional view depicting an inkjet apparatus according to a third embodiment of the present invention;

FIG. 10A is a vertical cross-sectional view depicting an inkjet apparatus according to a fourth embodiment of the present invention;

FIG. 10B is a vertical cross-sectional view depicting an inkjet apparatus according to a fourth embodiment of the present invention;

FIG. 11 is a vertical cross-sectional view depicting an inkjet apparatus according to a fifth embodiment of the present invention;

FIG. 12 is a vertical cross-sectional view depicting an inkjet apparatus according to a sixth embodiment of the present invention; and

FIG. 13 is a vertical cross-section view depicting a conventional inkjet apparatus.

### DESCRIPTION OF THE EMBODIMENTS

The embodiments will now be described with reference to the accompanying drawings, wherein like reference numerals designate corresponding or identical elements throughout the various drawings.

A liquid discharge device according to an embodiment of the present invention is applicable to an inkjet apparatus for printers.

### First Embodiment

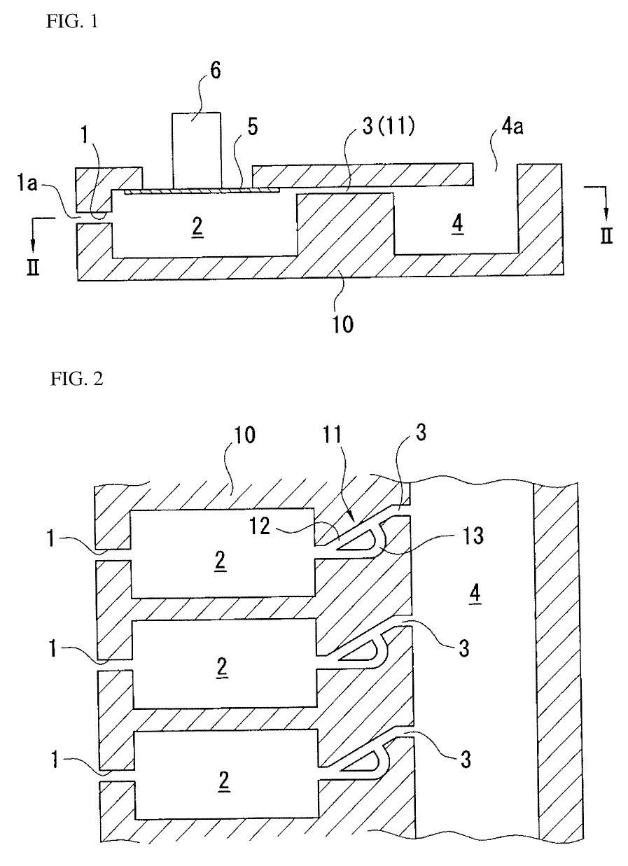

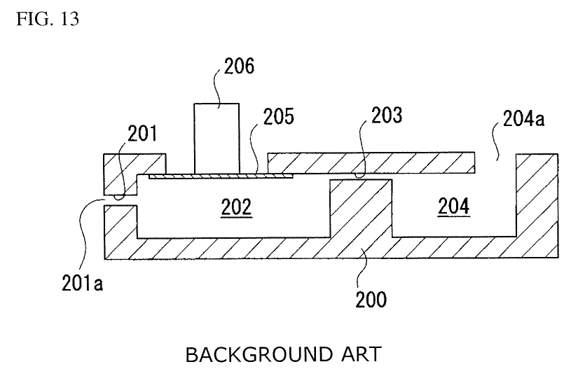

A description will be given below, an inkjet apparatus according to a first embodiment of the present invention, with reference to FIGS. 1 to 7. Referring to FIG. 1, this inkjet apparatus is similar to that shown in FIG. 13, because it also includes a head body 10, a nozzle opening 1, a pressure chamber 2, a liquid channel 3, a liquid supply chamber 4, a diaphragm 5 for covering an upper opening of the pressure chamber 2, and an actuator 6 such as a piezoelectric element for moving the diaphragm 5 vertically. Furthermore, the nozzle opening 1, the pressure chamber 2, the liquid channel 3, and the liquid supply chamber 4 are all formed within the head body 10.

Referring to FIG. 2, a printer head is composed of the above inkjet apparatuses arranged laterally. Furthermore, multiple nozzle openings 1 are arranged at the end of the head body 10. The liquid supply chamber 4 is formed of a single space and is common to the inkjet apparatuses.

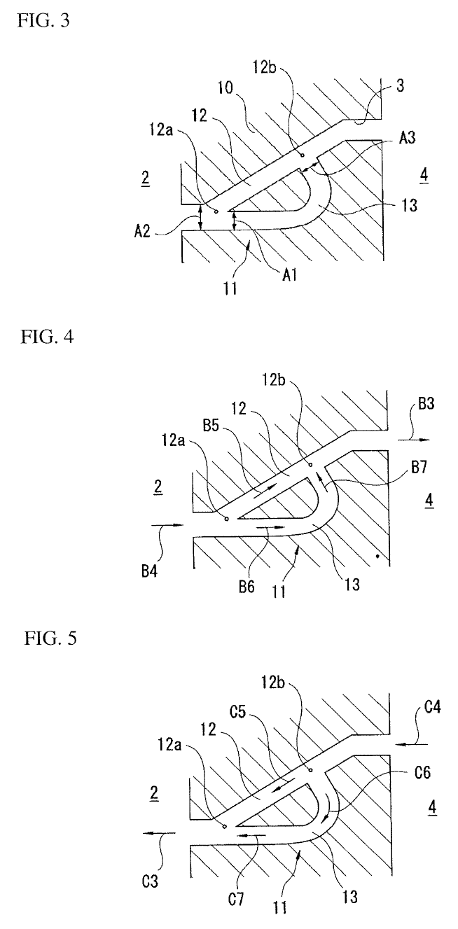

Referring to FIG. 3, each liquid channel 3 has a liquid valve (a fluid resistance providing mechanism or resistance means) 11 which includes a main channel 12 and a sub channel 13. The main channel 12 couples the pressure chamber 2 to the liquid supply chamber 4, and it may be straight or curved at an obtuse angle as shown in the figure. The sub channel 13 is separated from the main channel 12 at a downstream point 12a. In addition, the sub channel 13 is joined to the main channel 12 at an upstream point 12b. The sub channel 13 is separated so as to split the liquid current into two in the reverse direction. Furthermore, the sub channel 13 is joined to the main channel 12 such that the liquid flowing out of the sub channel 13 impinges into the liquid flowing in the main channel 12 at about a right angle.

Referring to FIG. 5, the forward current along a first flow direction, that is, the current from the liquid supply chamber 4 to the pressure chamber 2 is denoted by arrows. As shown by arrows C4, C5 and C3, the liquid flows mainly through the main channel 12. The amount of the liquid which flows in the direction shown by arrows C6 and C7 or which flows into the sub channel 13 at the upstream point 12b is small.

In contrast, the reverse current along a second flow direction, that is, the current from the pressure chamber 2 to the liquid supply chamber 4 is shown by arrows in FIG. 4. The main channel 12 and the sub channel 13 are joined together at the downstream point 12b. The liquid flowing from the sub channel 13 shown by arrows B6 and B7 is merged into the liquid passing through the main channel 12 shown by an arrow B5 at the upstream point 12b. As a result, the current of the liquid in the main channel 12 is disturbed, and the liquid valve 11 has a fluid resistance in the reverse direction. Accordingly, by providing the liquid channel 3 with the liquid valve 11, the liquid is allowed to flow smoothly through the main channel 12 in the forward direction. In other words, the fluid resistance (a first fluid resistance) in the forward direction is relatively low. In contrast, the liquid flowing into the main channel 12 in the reverse direction is disturbed by the liquid flowing out of the sub channel 13. Thus, the fluid resistance (a second fluid resistance) in the reverse direction is relatively high.

As the liquid current from the sub channel 13 to the main channel 12 at the upstream point 12b is stronger, the fluid resistance of the liquid valve 11 increases in the reverse direction.

In this case, it is preferable that the following relationship is satisfied:

A1>A2>A3, A1>A2, A2>A3 or A1>A3,

where A1 is represented by a cross section area of the sub channel 13 at the downstream point 12a,

A2 is represented by a cross section area of the main channel 12 at the downstream point 12a, and

A3 is represented by a cross section area of the sub channel 13 at the upstream point 12b.

The cross section of the sub channel 13 may decrease gradually from the downstream point 12a to the upstream point 12b. Furthermore, an angle at which the sub channel 13 is coupled to the main channel 12 at the upstream point 12b may be about a 90 degree. However, they are not essential. Alternatively, the sub channel 13 may be coupled to the main channel 12, while facing toward the downstream point 12a. This makes it possible to further increase the fluid resistance in the reverse direction.

Next, a description will be given, an operation of a printer equipped with the above inkjet apparatus.

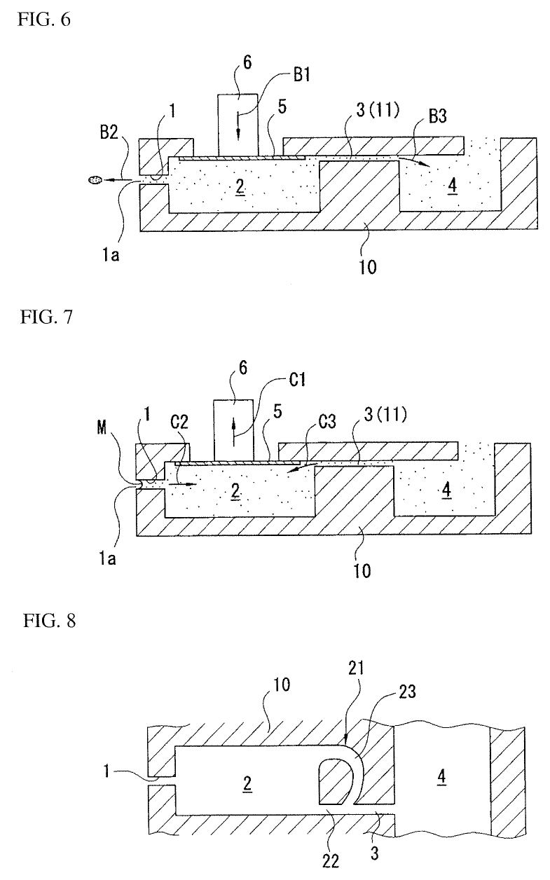

First, the actuator 6 is moved vertically by applying a predetermined voltage to a piezoelectric element. Following this, the diaphragm 5 displaces vertically. When the diaphragm 5 is moved by the actuator 6 in the direction of an arrow B1 of FIG. 6, that is, downward, the liquid pressure within the pressure chamber 2 is heightened. Then, the liquid ink is discharged from the end opening 1a of the nozzle opening 1 in the direction of an arrow B2. Consequently, the discharged liquid ink reaches a substrate positioned in front of the nozzle opening 1, so that characters or texts are printed on the substrate.

In this way, when the pressure of the pressure chamber 2 is heightened, the liquid is discharged from the nozzle opening 1. At the same time, the liquid is made to flow in the direction of an arrow B3, and is then supplied to the liquid supply chamber 4 through the liquid channel 3. Thus, the reverse current of the liquid is generated in the liquid channel 3. However, by providing the liquid channel 3 with the liquid valve 11, the liquid channel 3 has the large fluid resistance in the reverse direction. Therefore, the reverse current of the liquid is inhibited. As a result, the amount of the liquid supplied to the liquid supply chamber 4 decreases. This enables efficient printing operation to be attained. The above-described configuration is effective, especially, in order to increase the amount of the ink discharged from the nozzle opening 1, that is, to increase the discharged drop of the ink.

Next, when the diaphragm 5 is moved by the actuator 6 in the direction of an arrow C1 of FIG. 7, that is, upward, the volume of the pressure chamber 2 increases, so that its internal pressure is lowered. In this case, the liquid in the nozzle opening 1 is absorbed in the direction of an arrow C2, that is, toward the pressure chamber 2. However, the liquid stays at the end opening 1a while forming a meniscus due to its surface tension, thereby preventing air from entering the nozzle opening 1 through the end opening 1a. At the same time, the liquid in the liquid supply chamber 4 is absorbed in the direction of the arrow C3, that is, toward the liquid channel 3, and is supplied to the pressure chamber 2. In other words, the forward current of the liquid is generated in the liquid channel 3. In this case, the liquid valve 11 provided in the liquid channel 3 is configured to decrease the fluid resistance in the forward direction, and to allow the liquid to flow smoothly in the direction of the arrow C2.

As described above, when the diaphragm 5 is moved downward by the actuator 6 to thereby increase the internal pressure of the pressure chamber 2, the reverse current of the liquid in the liquid channel 3 is inhibited by the liquid valve 11. This makes it possible to allow the liquid to be discharged efficiently from the nozzle opening 1. As a result, the amount of the liquid discharged from the nozzle opening 1 increases. If the amount of the discharged liquid does not need to be large, then the distance over which the diaphragm 6 travels may be shortened. This enables the configuration of the inkjet apparatus to be made compact and simple.

When the diaphragm 5 is moved upward by the actuator 6 to thereby decrease the internal pressure of the pressure chamber 2, the liquid flows smoothly into the liquid channel 3 because of the liquid valve 11. Consequently, the liquid can be filled up within the pressure chamber 2 efficiently. This makes it possible to increase the speed of vertical movement of the diaphragm 5, thereby achieving high-speed printing operation. In addition, due to the fact that the liquid flows into the pressure chamber 2 smoothly, the rapid reduction in the internal pressure of the pressure chamber 2 is prevented. This enables the behavior of the inkjet apparatus to be stable.

In FIG. 13, when the diaphragm 205 is moved upward by the actuator 206, the liquid in the liquid supply chamber 204 is supplied to the pressure chamber 202. The liquid channel 203 has a fluid resistance in the reverse direction, as described above. This fluid resistance is prone to limit the liquid current from the liquid supply chamber 204 to the pressure chamber 202, that is, in the forward direction. Thus, although the fluid resistance is necessary to inhibit the liquid from flowing in the reverse direction when the liquid is discharged, it also limits the liquid current in the forward direction. Therefore, it takes long time to fill the liquid in the pressure chamber 202, thereby prolonging the intervals of the discharge. As a result, a printer equipped with the above inkjet apparatus could have long printing time.

Accordingly, the liquid channel 203 needs to have a large fluid resistance in the reverse direction when the liquid is discharged from the end opening 201a of the nozzle opening 201. Also, it needs to have a small resistance in the forward direction. In order to realize this function, a mechanical passive valve may be used.

However, the frequency of operation of the actuator 206, that is, the variation frequency of the liquid pressure within the pressure chamber 202 exceeds several kHz. A typical mechanical passive valve is hard to operate at such a high frequency. Even if it manages to operate, its life time could be short due to the degradation of its strength. Moreover, some type of liquid ink contains distributed pieces of a solid material. If liquid ink of this type is used, then the pieces of a solid material adhere to a mechanical passive valve. This may cause the deterioration of the valve.

Furthermore, inkjet nozzles are arranged closely, for example, at the intervals of 0.1 mm. In addition, the pressure chamber 202 and the liquid channel 203 are very small. It is almost impossible to install mechanical valves into such small areas.

Alternatively, a liquid channel which can change its cross section area in response to the timing of the discharge or charge of the liquid may be used. However, this structure is expensive and complex. It may not be practical in terms of its cost and reliability.

According to the embodiment of the present invention, a simple liquid discharge device is provided which is easy to assemble, which charges or discharges liquid with high efficiency, and which has a large fluid resistance in the reverse direction and a low fluid resistance in the forward direction.

### Second Embodiment

Next, a description will be given below, an inkjet apparatus according to a second embodiment of the present invention, with reference to FIG. 8. The same reference numerals are given to the same parts as those already described in the first embodiment, and duplicate description therefore is omitted. The inkjet apparatus of the second embodiment includes a head body 10, a nozzle opening 1, a pressure chamber 2, a liquid channel 3, a liquid supply chamber 4, a diaphragm for covering an upper opening of the pressure chamber 2, and an actuator for moving the diaphragm vertically. In addition, the nozzle opening 1, the pressure chamber 2, the liquid channel 3 and the liquid supply chamber 4 are all formed within the head body 10. Note that the diaphragm and the actuator are not shown in the figure.

The inkjet apparatus has a liquid valve 21 located where the pressure chamber 2 is coupled to the liquid channel 3. This liquid valve 21 includes a main channel 22 and a sub channel 23, and it allows the liquid to flow smoothly in the forward direction, but has a large fluid resistance in the reverse direction. Since this mechanism and behavior are similar to those of the first embodiment, its detailed explanation is omitted.

### Third Embodiment

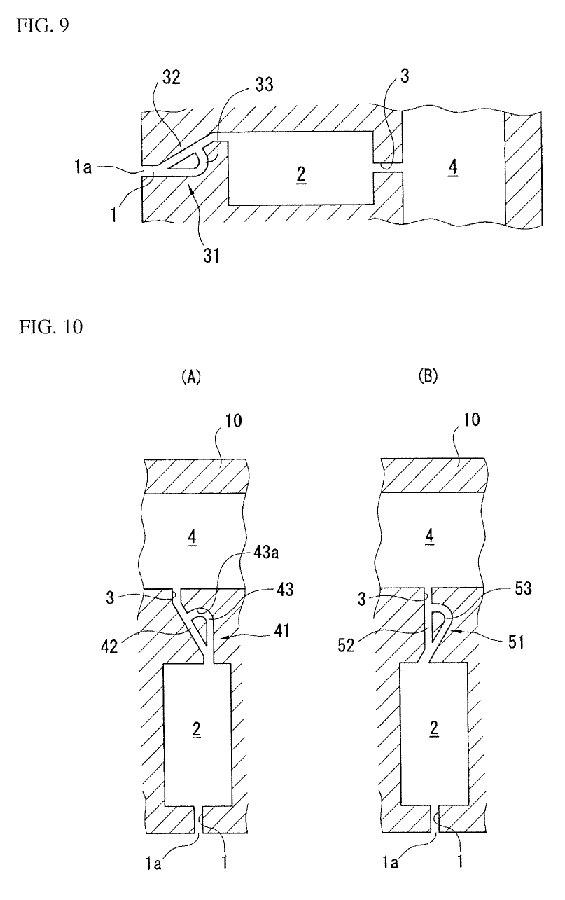

Now, a description will be given below, of a third embodiment of the present invention, with reference to FIG. 9. The same reference numerals are given to the same parts as those already described in the first embodiment, and duplicate description therefore is omitted. An inkjet apparatus of a third embodiment includes a head body 10, a nozzle opening 1, a pressure chamber 2, a liquid channel 3, a liquid supply chamber 4, a diaphragm for covering an upper opening of the pressure chamber 2, and an actuator for moving the diaphragm vertically. In addition, the nozzle opening 1, the pressure chamber 2, the liquid channel 3, and the liquid supply chamber 4 are all formed within the head body 10. Note that the diaphragm and the actuator are not shown in the figure.

This inkjet apparatus has a liquid valve 31 located in the nozzle opening 1 or between the pressure chamber 2 and the end opening 1a of the nozzle opening 1. This liquid valve 31 includes a main channel 32 and a sub channel 33, and it allows the liquid to flow smoothly in the forward direction, but has a large fluid resistance in the reverse direction.

With the above configuration, when the liquid pressure in the pressure chamber 2 is high, the liquid is discharged from the nozzle opening 1 smoothly. Meanwhile, when the pressure is low, pressure drawn toward the nozzle opening 1 is attenuated by the fluid resistance, thereby preventing the meniscus of the liquid at the end of the nozzle opening 1 from moving toward the interior of the nozzle opening 1. As described above, by providing the liquid valve 31 with the sub channel 33, even if the liquid pressure in the pressure chamber 2 is much lower than its surroundings, the meniscus of the liquid is kept at it is. This makes it possible to increase the amount of the liquid supplied to the pressure chamber 2 from the liquid supply chamber 4 through the liquid channel 3. Consequently, it is possible to achieve quick vertical movement of the diaphragm, thereby leading to the high-speed printing operation. Moreover, the reverse current of the liquid in the nozzle opening 1 is inhibited. Accordingly, even if the nozzle opening 1 is enlarged, the meniscus is kept as it is. Therefore, the entry of air is blocked, thereby leading to the increase in the amount of the liquid discharged from the nozzle opening 1.

### Fourth Embodiment

Referring to FIGS. 10A and 10B, an inkjet apparatus similar to that of the first embodiment in a printer head is placed, while an end 1a of a nozzle opening 1 faces below.

Referring to FIG. 10A, a liquid valve 41 includes a sub channel 43 curved in such a way that its out-curved portion faces upward. In this configuration, air bubble is prone to be produced around a curved portion 43. If air bubble is generated at the curved portion 43a, then the volume of the air bubble could be changed depending on the liquid pressure in the pressure chamber 2. Consequently, the response of the pressure in the pressure chamber 2 to the movement of the diaphragm is delayed. This may cause the incorrect control of the liquid discharge.

In consideration of the above disadvantage, it is preferable that a liquid valve 51 includes a main channel 52 and a sub channel 53 that both extend in an upward or slanting position, as an inkjet apparatus shown in FIG. 10B.

### Fifth Embodiment

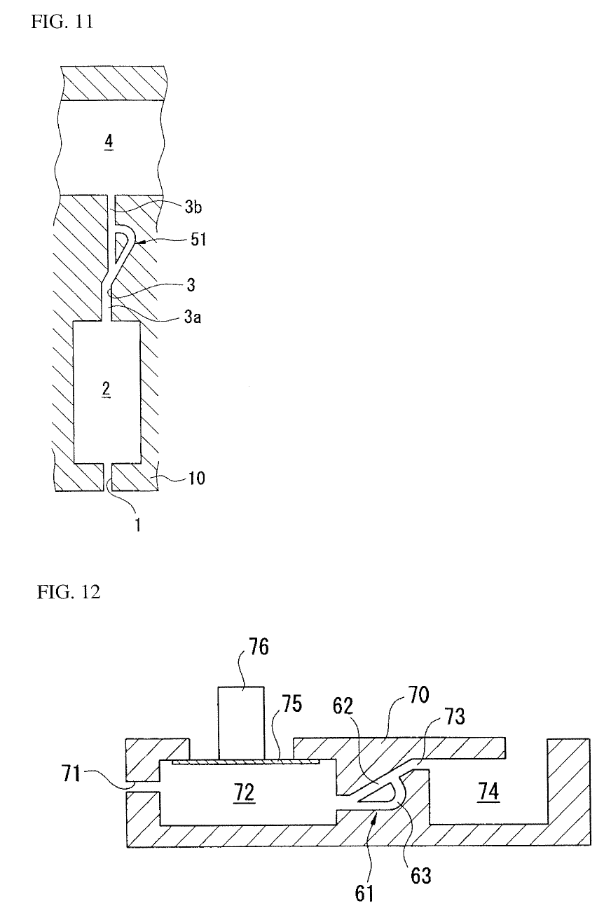

A description will be given, of an inkjet apparatus according to a fifth embodiment of the present invention, with reference to FIG. 11. This inkjet apparatus is similar to that of the fourth embodiment, because it includes the same liquid valve 51 as that of FIG. 10B. However, the inkjet apparatus according to the fifth embodiment differs from that of the fourth embodiment in that it includes a relatively long first liquid path 3a that couples a pressure chamber 2 to a liquid valve 51 and a relatively long second liquid path 3b that couples a liquid supply chamber 4 to a liquid valve 51. With those long first and second liquid paths 3a and 3b, the forward liquid current from the liquid supply chamber 4 is rectified by the second liquid path 3b. This allows the liquid to flow smoothly from the main channel 52 in the forward direction. In addition, the liquid is made to flow smoothly from the pressure chamber 2 to the main and sub channels 52 and 53.

### Sixth Embodiment

A description will be given, of an inkjet apparatus according to a sixth embodiment of the present invention, with reference to FIG. 12. This inkjet apparatus includes a head body 70, a nozzle opening 71, a pressure chamber 72, a liquid channel 73, a liquid supply chamber 74, a diaphragm 75 for covering an upper opening of the pressure chamber 72, and an actuator 76 for moving the diaphragm 75 vertically. In addition, the nozzle opening 71, the pressure chamber 72, the liquid channel 73 and the liquid supply chamber 74 are all formed within the head body 70. Its configuration is similar to that of the fifth embodiment. However, while the liquid valve of the first to fifth embodiments is formed perpendicular to the direction in which the actuator moves, that is, perpendicular to the plane of the paper of FIG. 1, the inkjet apparatus of this embodiment has a liquid valve 61 formed horizontally. However, the liquid valve 61 includes a main channel 62 and a sub channel 63, and its behavior is similar to those of the above-described embodiments. This configuration can be implemented easily by stacking thin plates each of which has holes at predetermined locations.

In order to manufacture the above-described liquid discharge devices (inkjet apparatuses), high precision process is necessary. A wet etching process, which is typically used for processing inkjet apparatuses, is not appropriate, because it is impossible to form curved channels due to a crystal axis of silicon.

To form curved channels, the electroforming process employing plating technique can be used. This process is to form a resin mask by using photo fabrication. By the electroforming process, free curve surface can be formed by using a photo mask.

Instead, a photosensitive glass may be used to form an etching area with a photo fabrication.

From the aforementioned explanation, those skilled in the art ascertain the essential characteristics of the present invention and can make the various modifications and variations to the present invention to adapt it to various usages and conditions without departing from the spirit and scope of the claims.

Obviously, numerous modifications and variations of the present invention are possible in light of the above teachings. It is therefore to be understood that within the scope of the appended claims, the invention may be practiced otherwise than as specifically described herein.

What is claimed as new and is desired to be secured by Letters Patent of the United States is:

1. A liquid discharge apparatus comprising:
a nozzle;
a pressure chamber in which a liquid pressure is configured to be changed to discharge liquid from the nozzle;
a nozzle passage connecting the pressure chamber and the nozzle;
a liquid supply chamber;
a liquid supply passage connecting the liquid supply chamber and the pressure chamber; and
a fluid resistance providing mechanism provided in at least one of the liquid supply passage and the nozzle passage, a first fluid resistance of the fluid resistance providing mechanism along a first flow direction from the liquid supply chamber toward the nozzle being smaller than a second fluid resistance of the fluid resistance providing mechanism along a second flow direction from the nozzle toward the liquid supply chamber.

2. The liquid discharge apparatus according to claim 1, wherein the pressure chamber is provided with a piezoelectric element which is configured to be vibrated to change the liquid pressure in the pressure chamber.

3. The liquid discharge apparatus according to claim 1, wherein the fluid resistance providing mechanism comprising:
a main passage; and
a sub passage merged with the main passage, a second liquid flow in the sub passage impeding a first liquid flow in the main passage in the second flow direction to increase the second fluid resistance of the fluid resistance providing mechanism.

4. The liquid discharge apparatus according to claim 3, wherein the sub passage diverges from the main passage in the second flow direction forming an acute angle between the sub passage and the main passage and merges with the main passage forming substantially a right angle between the sub passage and the main passage.

5. The liquid discharge apparatus according to claim 3, wherein a cross-sectional area of the sub passage decreases along the second flow direction.

6. The liquid discharge apparatus according to claim 3, wherein the main passage connects the liquid supply chamber and the pressure chamber, and wherein the sub passage is connected to the pressure chamber and merges with the main passage forming substantially a right angle between the sub passage and the main passage.

7. The liquid discharge apparatus according to claim 3, wherein the fluid resistance providing mechanism is so constructed not to have gaseous bubble.

8. The liquid discharge apparatus according to claim 3, wherein the pressure chamber is provided with a piezoelectric element which is configured to be vibrated in a vibration direction to change the liquid pressure in the pressure chamber, and wherein the main passage and the sub passage extend substantially parallel to a plain perpendicular to the vibration direction.

9. The liquid discharge apparatus according to claim 3, wherein the pressure chamber is provided with a piezoelectric element which is configured to be vibrated in a vibration direction to change the liquid pressure in the pressure chamber, and wherein the main passage and the sub passage extend substantially parallel to a plain parallel to the vibration direction.

10. The liquid discharge apparatus according to claim 1, wherein the fluid resistance providing mechanism is electroformed.

11. The liquid discharge apparatus according to claim 1, wherein the fluid resistance providing mechanism is made from glass.

12. A liquid discharge apparatus comprising:
a nozzle;
a pressure chamber in which a liquid pressure is configured to be changed to discharge liquid from the nozzle;
a nozzle passage connecting the pressure chamber and the nozzle;
a liquid supply chamber;
a liquid supply passage connecting the liquid supply chamber and the pressure chamber; and
resistance means for providing fluid resistance provided in at least one of the liquid supply passage and the nozzle passage, a first fluid resistance of the resistance means along a first flow direction from the liquid supply chamber toward the nozzle being smaller than a second fluid resistance of the resistance means along a second flow direction from the nozzle toward the liquid supply chamber.

13. The liquid discharge apparatus according to claim 12, wherein the pressure chamber is provided with pressure means for changing the liquid pressure in the pressure chamber.

14. An inkjet printer comprising:
a nozzle;
a pressure chamber in which an ink pressure is configured to be changed to discharge ink from the nozzle;
a nozzle passage connecting the pressure chamber and the nozzle;
an ink supply chamber;
an ink supply passage connecting the ink supply chamber and the pressure chamber; and
a fluid resistance providing mechanism provided in at least one of the ink supply passage and the nozzle passage, a first fluid resistance of the fluid resistance providing mechanism along a first flow direction from the ink supply chamber toward the nozzle being smaller than a second fluid resistance of the fluid resistance providing mechanism along a second flow direction from the nozzle toward the ink supply chamber.

15. A liquid discharging method comprising:
providing a fluid resistance providing mechanism in at least one of a liquid supply passage and a nozzle passage, the liquid supply passage connecting a liquid supply chamber and a pressure chamber, the nozzle passage connecting the pressure chamber and a nozzle, a first fluid resistance of the fluid resistance providing mechanism along a first flow direction from the liquid supply chamber toward the nozzle being smaller than a second fluid resistance of the fluid resistance providing mechanism along a second flow direction from the nozzle toward the liquid supply chamber; and
changing a liquid pressure in the pressure chamber to discharge liquid from the nozzle.
